(19) United States
(12) Patent Application Publication
(10) Pub. No.: US 2016/0289434 A1
(43) Pub. Date: Oct. 6, 2016

(54) SOLID-STATE SHEAR PULVERIZATION OF POLYMER MIXTURES

(71) Applicant: Zzyzx Polymers LLC, Allentown, PA (US)

(72) Inventors: Mark Tapsak, Bloomsburg, PA (US); Philip Brunner, Easton, PA (US)

(21) Appl. No.: 15/092,124

(22) Filed: Apr. 6, 2016

Related U.S. Application Data
(60) Provisional application No. 62/143,315, filed on Apr. 6, 2015.
(60) Provisional application No. 62/163,444, filed on May 19, 2015.

(51) Int. Cl. C08L 23/06

(52) U.S. Cl. CPC C08L 23/06; C08L 2205/025; C08L 2207/062; C08L 2207/068

(57) ABSTRACT

This disclosure describes a composition including an ultra-high molecular weight polymer and a low molecular weight polymer and having a bimodal molecular weight distribution and articles including the composition. This disclosure further describes methods including providing a mixture of an ultra-high molecular weight polymer and a low molecular weight polymer, and applying solid-state shear pulverization to the mixture to form a bimodal molecular weight alloy. This disclosure also describes methods that include providing a mixture including a first polymer and a second polymer, and applying solid-state shear pulverization to the mixture to disperse the first polymer in the second polymer.

### CONTINUING APPLICATION DATA

This application claims the benefit of U.S. Provisional Application Ser. No. 62/143,315, filed Apr. 6, 2015, and U.S. Provisional Application Ser. No. 62/163,444, filed May 19, 2015, each which is incorporated by reference herein.

### GOVERNMENT FUNDING

This invention was made with government support under award number 1434826, awarded by the National Science Foundation. The government has certain rights in the invention.

### BACKGROUND

Although twin-screw extrusion (TSE) is a prominent technique for processing pure polymers, polymer composites, nanocomposites, and polymer blends, the shear mixing, long period of exposure to high temperature conditions, and viscosity mismatch of certain polymer systems leads to ineffective mixing certain types of polymers using TSE.

### SUMMARY OF THE INVENTION

This disclosure describes a composition including an ultra-high molecular weight polymer and a low molecular weight polymer and having a bimodal molecular weight distribution. In some embodiments the composition is a polymer alloy. The ultra-high molecular weight polymer can have a number average molecular weight of at least 500,000 g/mol. The low molecular weight polymer can have a number average molecular weight of up to 500,000 g/mol.

This disclosure further describes articles including the composition.

This disclosure also describes methods including providing a mixture of an ultra-high molecular weight polymer and a low molecular weight polymer, and applying solid-state shear pulverization (SSSP) to the mixture to form a bimodal molecular weight alloy. The solid-state shear pulverization can be applied at a temperature below the melting temperature of the low molecular weight polymer and/or below the glass transition temperature of the low molecular weight polymer.

This disclosure further describes methods including providing a mixture including a first polymer and a second polymer, and applying solid-state shear pulverization to the mixture to disperse the first polymer in the second polymer. The first polymer includes an ultra-high molecular weight polymer having a number average molecular weight of at least 500,000 g/mol.

The first polymer can include an ultra-high molecular weight polyethylene. The second polymer can include a polymer having a number average molecular weight of up to 500,000 g/mol. The first polymer and the second polymer can have different viscosities.

The method can further include forming a biaxial-orientated film, a fiber, a sealant, a roto-molding powder, or a foam.

As used herein, the term “liquefication” is defined as a phase transition of a polymer material from a solid state to a softened, liquid, or near-liquid state. The term “liquefication temperature” is defined as a temperature at which the polymer material transitions from a solid state to a softened, liquid, or near-liquid state. For a semi-crystalline polymer, a “liquefication temperature” may correspond to a melting point temperature. For an amorphous polymer, a “liquefication temperature” may correspond to a glass transition temperature. Some polymers may exist as combinations or admixtures of semi-crystalline and amorphous phases, and therefore the “liquefication temperature” may refer to either a melting point temperature or a glass transition temperature depending on the material composition.

The words “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the invention.

The terms “comprises” and variations thereof do not have a limiting meaning where these terms appear in the description and claims.

Unless otherwise specified, “a,” “an,” “the,” and “at least one” are used interchangeably and mean one or more than one.

Also herein, the recitations of numerical ranges by endpoints include all numbers subsumed within that range (e.g., 1 to 5 includes 1, 1.5, 2, 2.75, 3, 3.80, 4, 5, etc.).

For any method disclosed herein that includes discrete steps, the steps may be conducted in any feasible order. And, as appropriate, any combination of two or more steps may be conducted simultaneously.

The above summary of the present invention is not intended to describe each disclosed embodiment or every implementation of the present invention. The description that follows more particularly exemplifies illustrative embodiments. In several places throughout the application, guidance is provided through lists of examples, which examples can be used in various combinations. In each instance, the recited list serves only as a representative group and should not be interpreted as an exclusive list.

### BRIEF DESCRIPTION OF THE FIGURES

FIG. 1 shows a schematic of one embodiment of an instrumentation set-up and operating conditions for the SSSP processing method described herein.

### DETAILED DESCRIPTION OF ILLUSTRATIVE EMBODIMENTS

This disclosure describes the manufacture of polymer alloys including polymers having significant viscosity and molecular weight mismatches using solid-state shear pulverization (SSSP). For example, SSSP may be used to form a composition that includes an ultra-high molecular weight polymer and a low molecular weight polymer and having a bimodal molecular weight distribution.

Combining different polymer types into a hetero-polymeric composition can be limited by the physical-chemical properties of the individual polymers. Combining miscible polymers of the same type (e.g., including the same components) but having greatly differing molecular weights may also be limited by the physical-chemical properties of the individual polymers. For example, polymers that differ in one or more of their liquefication temperature, viscosity, and density may not readily combine in a homogeneous manner when in a liquid or softened state. Micro phase separation between polymers may occur for suspensions of melted or softened polymers that differ in their viscosity. For example, combination of recycled polymers having added colorants may result in inhomogeneously colored products due to micro phase separation of the colorant materials. It is therefore apparent that combining polymers into hetero-polymeric compositions by melting the initial components may not result in favorable component mixing.

Twin-screw extrusion (TSE) is often used to process homo-polymers, copolymers, and polymer blends from virgin and/or recycled sources. TSE has also been applied in the production of polymer composites and nano-composites. However, the shear mixing of TSE is often insufficiently rigorous to create a homogenous material in polymer blends. Additionally, TSE may not be effective for exfoliating (separating) or dispersing (spreading) fillers within a polymer matrix to form composites or nano-composites. Further, long TSE processing times may expose the extrusion materials to high temperature conditions that may result in thermal degradation of the initial materials. Such limitations may render TSE ineffective for producing high-performance polymer blends, composites, and nanocomposites.

Solid-state shear pulverization (SSSP) can improve the mixing of immiscible polymer blends, compared to TSE. SSSP can, preferably, apply a mechanical energy to a mixture, effecting a chemical change to the mixture. SSSP can also exfoliate or disperse fillers in polymer composites or nano-fillers in nanocomposites.

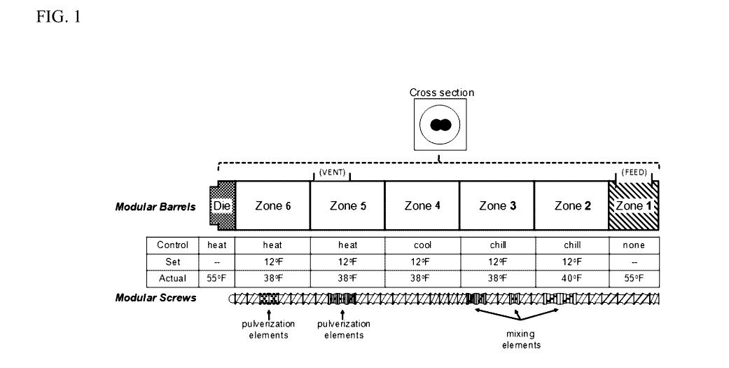

Referring to FIG. 1, a schematic is shown of the instrumentation set-up and typical operating conditions for the SSSP processing method of the present invention. The SSSP processing method can be optimized by varying the apparatus, components, and operation conditions of a twin-screw extruder and/or SSSP device, as described, for example, in U.S. Pat. Nos. 5,814,673; 6,180,685; 6,818,173; and 7,223,359, each of which is incorporated herein by reference for their description of solid-state shear pulverization (SSSP).

In some embodiments, the twin-screw extruder has modular barrel zones with individual temperature settings. The SSSP processing technique may, in some embodiments, be designed to perform pulverization of the polymer below the melting point of semi-crystalline polymers or below the glass transition temperature of amorphous polymers.

In many embodiments, SSSP is performed by a device including a screw element and/or a screw shaft. In some embodiments, SSSP is performed by a device including a twin screw extruder. In some embodiments, a screw element includes rotating screws. The rotating screws can be modular. Non-limiting examples of shapes of the screw element include monolobe, bilobe, trilobe, quadralobe, pentalobe, etc. The screw element can function in forward, neutral, or reverse and can be used for kneading, mixing, pulverization, or conveying polymers and compounds. The screw element can include a metal, and in some embodiments, may be wholly made of metal. In addition, the screw element may be clad, layered or solid. Non-limiting examples of cross-sectional shapes of a screw shaft include hexagonal, rectangular, triangular, pentagonal, octagonal, spline, and round. In some embodiments, the shaft is threaded or unthreaded, bored to any length or unbored. The shaft may be of any overall length. The screw shaft can include a metal. The screw shaft can consist of a metal in whole or part. In addition the screw shaft may be clad, layered or solid.

In some embodiments, a screw element and/or a screw shaft form a screw configuration that enables the successful manufacturing of polymer alloys consisting of ultra-high molecular weight polymers with low molecular weight polymers creating a bimodal molecular weight.

Frictional heating of a composition during processing may lead to the composition being heated to a liquefication temperature or above a liquefication temperature of at least one component of the composition. Such frictional heating and liquefication may result in inhomogeneous mixing between components of a mixture including, for example, a high molecular weight polymer and a low molecular weight polymer. Thus, in some embodiments, SSSP is performed in the presence of sufficient cooling to maintain the composition in the solid state during pulverization. For example, the temperature of at least one extrusion screw of the extruder may be controlled to remove at least some of the friction-induced heat from the composition. In some embodiments, the temperature of the at least one extrusion screw may be maintained at a temperature less than or equal to the liquefication temperature of the composition or one component of the composition. In some embodiments, the temperature of the at least one extrusion screw may be maintained at a temperature less than or equal to the liquefication temperature of the component of the composition having the lowest liquefication temperature. In some embodiments, the temperature of the at least one extrusion screw may be maintained at a temperature less than or equal to the liquefication temperature of the low molecular weight polymeric material.

In one aspect, this disclosure describes a composition that includes an ultra-high molecular weight polymer and a low molecular weight polymer. The composition has a bi-modal molecular weight distribution. In some embodiments, the composition is a polymer alloy. The composition is preferably formed by SSSP.

In some embodiments, an ultra-high molecular weight polymer is a polymer that softens at a liquefication temperature and experiences little to no flow above the liquefication temperature. In some embodiments, an ultra-high molecular weight polymer is a polymer having a number average molecular weight of at least 500,000 g/mol, at least 1×10⁶ g/mol, at least 2×10⁶ g/mol, at least 5×10⁶ g/mol. In some embodiments, the ultra-high molecular weight polymer includes a polyolefin, a polystyrene, a polypropylene, a polyethylene, a polyvinylchloride, or a fluoropolymer, or a combination thereof (e.g., a mixture or copolymer, thereof). The ultra-high molecular weight polymer can include a virgin and/or recycled polymer.

In some embodiments, a low molecular weight polymer is a polymer that material that softens at a liquefication temperature and has the ability to flow above its liquefication temperature. In some embodiments, a low molecular weight polymer is a polymer having a number average molecular weight of up to 500,000 g/mol, up to 400,000 g/mol, up to 300,000 g/mol, up to 200,000 g/mol. In some embodiments, the low molecular weight polymer includes a polyolefin, a polystyrene, a fluoropolymer, a polyamide, an acrylonitrile butadiene styrene (ABS), a polypropylene, a polyethylene, a polyvinylchloride, or a polycarbonate, or a combination thereof (e.g., a mixture or copolymer, thereof). In some embodiments, a polystyrene includes a high impact polystyrene. The low molecular weight polymer can include a virgin and/or recycled polymer.

Useful combination of an ultra-high molecular weight polymer and a low molecular weight polymer include an ultra-high molecular weight polymer having a molecular weight greater than 1×10⁶ g/mol and a low molecular weight polymer having a number average molecular weight of up to 500,000 g/mol, up to 400,000 g/mol, up to 300,000 g/mol, up to 200,000 g/mol.

The ultra-high molecular weight polymer and the low molecular weight polymer may be mixed in any suitable proportion. In some embodiments, the ultra-high molecular weight polymer and the low molecular weight polymer can be mixed in the proportions shown in Table 1.

TABLE 1
Compositions for homopolymer and polymer blends from virgin and/or recycled materials with ultra-high
molecular weight (greater than 500,000 g/mol) and low molecular weight (less than 500,000 g/mol).

| | Material | | | | | | |
|---|---|---|---|---|---|---|---|
| | Virgin and/or | Virgin and/or | Virgin and/or | Virgin and/or | Virgin and/or | Virgin and/or | Virgin and/or |
| | Recycled ultra- | Recycled ultra- | Recycled ultra- | Recycled | Recycled | Recycled | Recycled |
| | high molecular | high molecular | high molecular | low molecular | low molecular | low molecular | low molecular |
| | weight PE | weight PP | weight PS | weight PE | weight PP | weight PS | weight ABS |
| | (wt %) | (wt %) | (wt %) | (wt %) | (wt %) | (wt %) | (wt %) |
| Sample 1 | 75 | 0 | 0 | 25 | 0 | 0 | 0 |
| Sample 2 | 50 | 0 | 0 | 50 | 0 | 0 | 0 |
| Sample 3 | 25 | 0 | 0 | 75 | 0 | 0 | 0 |
| Sample 4 | 0 | 75 | 0 | 0 | 25 | 0 | 0 |
| Sample 5 | 0 | 50 | 0 | 0 | 50 | 0 | 0 |
| Sample 6 | 0 | 25 | 0 | 0 | 75 | 0 | 0 |
| Sample 7 | 0 | 0 | 75 | 0 | 0 | 25 | 0 |
| Sample 8 | 0 | 0 | 50 | 0 | 0 | 50 | 0 |
| Sample 9 | 0 | 0 | 25 | 0 | 0 | 75 | 0 |
| Sample 10 | 75 | 0 | 0 | 0 | 0 | 0 | 25 |
| Sample 11 | 40 | 0 | 0 | 10 | 0 | 0 | 50 |
| Sample 12 | 25 | 0 | 0 | 0 | 0 | 0 | 75 |

As shown in Example 1, a bimodal polymer alloy formed by SSSP that includes a high molecular weight polymer and low molecular weight polymer can exhibit improved mechanical properties including, for example, increased tensile impact strength and reduced melt flow compared to the low molecular weight polymer alone. Decreased melt flow has the potential to enable the use of different types of molding and the formation of new products. Moreover, the composition formed in Example 1 could be modified to include additional HDPE (thereby reducing the overall UHMWPE content) while still retaining some of the benefits of the alloy.

In some embodiments, a composition that includes an ultra-high molecular weight polymer and a low molecular weight polymer can include an ultra-high molecular weight polypropylene (UHMWPP) and a low molecular weight polypropylene (PP). For PP to be used in foaming, thermoforming, extrusion coating, blow molding, and similar processes, modifications are needed to enhance its strain hardening behavior. Creating a very broad molecular weight distribution (e.g., bimodal) can achieve improved strain hardening behavior. Likewise, other compositions, blends, and/or alloys may be used in foaming, thermoforming, extrusion coating, blow molding, and/or similar processes by enabling a broad molecular weight distribution using the present invention. Where polymer materials are already used in these processes, alloy formation can allow for improved processing conditions, more highly expanded foaming, and/or the production of thinner films by these or other processes.

The disclosure further describes an article that includes the composition including an ultra-high molecular weight polymer and a low molecular weight polymer. In some embodiments, the article consists of the composition. In some embodiments, the article is monolithic. In some embodiments, the article includes a plurality of void spaces.

The disclosure further describes an article that includes an SSSP-processed material. In some embodiments, the article is monolithic. In some embodiments, the article includes an SSSP-processed material and a material that is not processed by SSSP. In some embodiments, the article includes an SSSP-processed material and a plurality of void spaces. In some embodiments, the article includes an SSSP-processed material, a material that is not processed by SSSP, and a plurality of void spaces.

The disclosure also describes a method that includes providing a mixture of an ultra-high molecular weight polymer and a low molecular weight polymer and applying solid-state shear pulverization (SSSP) to the mixture to form a bimodal molecular weight alloy. In some embodiments, the method is preferably performed by a commercially available intermeshing, co-rotational twin-screw extruder.

In some embodiments applying SSSP to the mixture includes applying a mechanical energy to the mixture to effect a chemical change to the mixture.

In some embodiments, the solid-state shear pulverization is applied at a temperature below the melting temperature of the low molecular weight polymer. In some embodiments, the solid-state shear pulverization is applied at a temperature below the glass transition temperature of the low molecular weight polymer. In some embodiments, the method further includes cooling the mixture to maintain the temperature below the melting temperature and/or the glass transition temperature of the low molecular weight polymer. In some embodiments, the ultra-high molecular weight polymer and the low molecular weight polymer are maintained in a solid state during pulverization.

In some embodiments, the method further includes dispensing the alloy. Dispensing may include, for example, extruding the alloy or discharging particles of the alloy.

In some embodiments, an ultra-high molecular weight polymer is a polymer that softens at a liquefication temperature and experiences little to no flow above the liquefication temperature. In some embodiments, an ultra-high molecular weight polymer is a polymer having a number average molecular weight of at least 500,000 g/mol, at least 1×10⁶ g/mol, at least 2×10⁶ g/mol, at least 5×10⁶ g/mol. In some embodiments, the ultra-high molecular weight polymer includes a polyolefin, a polystyrene, a polypropylene, a polyethylene, a polyvinylchloride, or a fluoropolymer, or a combination thereof (e.g., a mixture or copolymer, thereof). The ultra-high molecular weight polymer can include a virgin and/or recycled polymer.

In some embodiments, a low molecular weight polymer is a polymer that softens at a liquefication temperature and has the ability to flow above its liquefication temperature. In some embodiments, a low molecular weight polymer has a number average molecular weight of up to 500,000 g/mol, up to 400,000 g/mol, up to 300,000 g/mol, up to 200,000 g/mol. In some embodiments, the low molecular weight polymer includes a polyolefin, a polystyrene, a fluoropolymer, a polyamide, an acrylonitrile butadiene styrene (ABS), a polypropylene, a polyethylene, a polyvinylchloride, or a polycarbonate, or a combination thereof (e.g., a mixture or copolymer, thereof). In some embodiments, a polystyrene includes a high impact polystyrene. The low molecular weight polymer can include a virgin and/or recycled polymer.

In another aspect this disclosure describes a method including providing a mixture including a first polymer and a second polymer, and performing solid-state shear pulverization of the mixture to disperse the first polymer in the second polymer. The first polymer is an ultra-high molecular weight polymer having a number average molecular weight of at least 500,000 g/mol. In some embodiments, the first polymer is a polymer has a number average molecular weight of at least 1×10⁶ g/mol, at least 2×10⁶ g/mol, at least 5×10⁶ g/mol.

In some embodiments, an ultra-high molecular weight polymer is a polymer that softens at a liquefication temperature and experiences little to no flow above the liquefication temperature. In some embodiments, the ultra-high molecular weight polymer includes a polyolefin, a polystyrene, a polypropylene, a polyethylene, a polyvinylchloride, or a fluoropolymer, or a combination thereof (e.g., a mixture or copolymer, thereof). The ultra-high molecular weight polymer can include a virgin and/or recycled polymer.

In some embodiments, the first polymer includes an ultra-high molecular weight polyethylene.

In some embodiments, the second polymer includes a polyolefin, a polypropylene, a polyethylene, a nylon, a polystyrene, an acrylonitrile butadiene styrene (ABS), a fluoropolymer, a polyamide, a polyvinylchloride, or a polycarbonate, or a combination thereof. In some embodiments, the second polymer includes a polymer having a number average molecular weight of up to 500,000 g/mol, up to 400,000 g/mol, up to 300,000 g/mol, up to 200,000 g/mol. In some embodiments, a polystyrene includes a high impact polystyrene. The low molecular weight polymer can include a virgin and/or recycled polymer.

In some embodiments, the first polymer and the second polymer have difference viscosities.

In some embodiments, the method further includes forming a material for use in a biaxial-orientated film, a fiber, a sealant, a roto-molding powder, or a foam. In some embodiments, the method includes forming a material for bonding dissimilar polymers. In some embodiments, the method further includes forming a biaxial-orientated film, a fiber, a sealant, a roto-molding powder, or a foam. In some embodiments, the mixture further includes a foaming agent or additive.

Materials useful for biaxial-orientated films can include, for example, UHMWPE and polypropylene. Such film materials can include, in some embodiments, 10% UHMWPE and 90% polypropylene. Such film materials can further include or alternatively include another polymer or polymer blend that can be used to produce biaxial-oriented films. Preferably the materials formed according to the method and including UHMWPE have a higher strength and/or superior surface properties than film materials with no UHMWPE.

Materials useful for fibers can include, for example, UHMWPE and polyethylene. Such fiber materials can include, in some embodiments, 10% UHMWPE and 90% polyethylene. Such fiber materials can further include or alternatively include another polymer or polymer blend that can be used to manufacture fibers. Preferably the materials formed according to the method and including UHMWPE have a higher strength and/or durability than fiber materials with no UHMWPE.

Materials useful for sealant materials can include, for example, polyethylene and polypropylene. Such sealant materials can include, in some embodiments, 50% polyethylene and 50% polypropylene. Such sealant materials can further include or alternatively include another polymer or polymer blends. Preferably the materials formed according to the method and including UHMWPE have an improved ability to adhere two dissimilar polymers and/or improved barrier properties than sealant materials with no UHMWPE.

Materials useful for roto-molding powders can include, for example, UHMWPE, polyethylene, polypropylene, nylon, or combinations thereof (e.g., mixtures and copolymers thereof). Such powder materials can include 60% polyethylene, 20% UHMWPE, and 20% polypropylene or 60% polyethylene, 20% UHMWPE and 20% nylon. Such powder materials can further include or alternatively include another polymer or polymer blends. Preferably the materials formed according to the method and including UHMWPE have improved impact resistance and/or stiffness than powder materials with no UHMWPE.

Materials useful for bonding dissimilar polymers can include, for example, a mixture of the two dissimilar materials to be bonded together. In some embodiments, the ratio of the materials may be 50:50. For example to bond a polyethylene thin film to a polypropylene thin film, the bonding material could include 50% polyethylene and 50% polypropylene. This material could be cast between the two homopolymer layers and can act as a tie layer to improve the bonding between the two layers.

Materials useful for preparing foams can include, for example, UHMWPE and another polymer including, for example, polypropylene. Such foam-preparing materials may further contain foaming agents such as blowing agents, nucleating agents, cross-linking agents, or a combination thereof. Such foam-preparing materials can include UHMWPE, polypropylene, and a foaming agent. Such foam-preparing materials can include 60% UHMWPE, 35% polypropylene, and 5% foaming agent. These foam-preparing materials preferably enable the foam to have a finer plurality of uniform voids, which can allow for more precise thermoforming or injection molding of the foamed articles and can improve other material properties of the foam.

In some embodiments, the method is used to prepare materials useful for compatibilizing polymers and improving flow characteristics for molding processes and foaming. For example, the material can be added in a range of 2% to 10% by weight to a base polymer to compatibilize dissimilar polymers, to improve flow characteristics, and/or to improve material properties of the product.

The present invention is illustrated by the following examples. It is to be understood that the particular examples, materials, amounts, and procedures are to be interpreted broadly in accordance with the scope and spirit of the invention as set forth herein.

### EXAMPLES

### Example 1

A bimodal polymer alloy including a high molecular weight polymer (30 wt %, UHMWPE, average molecular weight in range of 3,000,000 g/mol to 6,000,000 g/mol, as reported by the supplier, Sigma Aldrich, St. Louis, Mo.) and low molecular weight polymer (70 wt %, HDPE, having a molecular weight of less than 500,000 g/mol) was produced by SSSP. Mechanical properties of the alloy are shown in Table 2. The alloy exhibits a nearly 50% increase in the tensile impact strength compared to an HDPE homopolymer. Furthermore, the melt flow index is significantly reduced by addition of UHMWPE.

TABLE 2
Properties of a HDPE homopolymer
and a bimodal HDPE/UHMWPE alloy

| | | | | HDPE/ |
|---|---|---|---|---|
| | | | HDPE | UHMWPE |
| Properties | Method | Units | Homopolymer | Alloy |
| Tensile | ASTM | psi | 4100 | 3600 |
| Strength, Yield | D638 | | | |
| Elongation at | ASTM | % | 560 | 140 |
| Break | D638 | | | |
| Tensile Impact | ASTM | ft-lb/in² | 90.0 | 131 |
| Strength | D1822 | | | |
| Melt Flow | ASTM | g/10 min @ | 0.30 | <0.1 |
| Index | D1238 | Load 2.16 kg, | | |
| | | Temp 190° C. | | |

Kusy R P, Whitley J Q. J Biomed Mater Res. 1986 November-December; 20(9):1373-89.
Sobieraj M C, Rimnac C M. J Mech Behav Biomed Mater. 2009 October; 2(5):433-43.
Mirian F. D., Wesley R. B., John M. T. Polymer. 2014 vol 55, pages 4948-4958

The complete disclosure of all patents, patent applications, and publications, and electronically available material cited herein are incorporated by reference. In the event that any inconsistency exists between the disclosure of the present application and the disclosure(s) of any document incorporated herein by reference, the disclosure of the present application shall govern. The foregoing detailed description and examples have been given for clarity of understanding only. No unnecessary limitations are to be understood therefrom. The invention is not limited to the exact details shown and described, for variations obvious to one skilled in the art will be included within the invention defined by the claims.

Unless otherwise indicated, all numbers expressing quantities of components, molecular weights, and so forth used in the specification and claims are to be understood as being modified in all instances by the term “about.” Accordingly, unless otherwise indicated to the contrary, the numerical parameters set forth in the specification and claims are approximations that may vary depending upon the desired properties sought to be obtained by the present invention. At the very least, and not as an attempt to limit the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. All numerical values, however, inherently contain a range necessarily resulting from the standard deviation found in their respective testing measurements.

All headings are for the convenience of the reader and should not be used to limit the meaning of the text that follows the heading, unless so specified.

What is claimed is:

1. A composition comprising an ultra-high molecular weight polymer and a low molecular weight polymer, wherein the composition has a bimodal molecular weight distribution.

2. The composition of claim 1, wherein the ultra-high molecular weight polymer has a number average molecular weight of at least 500,000 g/mol.

3. The composition of claim 1, wherein the low molecular weight polymer has a number average molecular weight of up to 500,000 g/mol.

4. The composition of claim 1, wherein the ultra-high molecular weight polymer comprises a polyolefin, a polystyrene, a polypropylene, a polyethylene, a polyvinylchloride, or a fluoropolymer, or a combination thereof.

5. The composition of claim 1, wherein the low molecular weight polymer comprises a polyolefin, a polystyrene, a fluoropolymer, a polyamide, an acrylonitrile butadiene styrene (ABS), a polypropylene, a polyethylene, a polyvinylchloride, or a polycarbonate, or a combination thereof.

6. The composition of claim 1, wherein the composition is a polymer alloy.

7. An article comprising the composition of claim 1.

8. A method comprising:
providing a mixture of an ultra-high molecular weight polymer and a low molecular weight polymer;
applying solid-state shear pulverization to the mixture to form a bimodal molecular weight alloy.

9. The method of claim 8, wherein the solid-state shear pulverization is applied at a temperature below the melting temperature of the low molecular weight polymer.

10. The method of claim 8, wherein the solid-state shear pulverization is applied at a temperature below the glass transition temperature of the low molecular weight polymer.

11. The method of claim 8, wherein the ultra-high molecular weight polymer has a number average molecular weight of at least 500,000 g/mol.

12. The method of claim 8, wherein the low molecular weight polymer has a number average molecular weight of up to 500,000 g/mol.

13. The method of claim 8, wherein the ultra-high molecular weight polymer comprises a polyolefin, a polystyrene, a polypropylene, a polyethylene, a polyvinylchloride, or a fluoropolymer, or a combination thereof.

14. The method of claim 8, wherein the low molecular weight polymer comprises a polyolefin, a polystyrene, a fluoropolymer, a polyamide, an acrylonitrile butadiene styrene (ABS), a polypropylene, a polyethylene, a polyvinylchloride, or a polycarbonate, or a combination thereof.

15. A method comprising:
providing a mixture comprising a first polymer and a second polymer, wherein the first polymer comprises an ultra-high molecular weight polymer having a number average molecular weight of at least 500,000 g/mol; and
applying solid-state shear pulverization to the mixture to disperse the first polymer in the second polymer.

16. The method of claim 15, wherein the first polymer comprises an ultra-high molecular weight polyethylene.

17. The method of claim 15, wherein the second polymer comprises polypropylene, polyethylene, nylon, polystyrene, acrylonitrile butadiene styrene (ABS), a polyvinylchloride, or a polycarbonate, or a combination thereof.

18. The method of claim 15, wherein the second polymer comprises a polymer having a number average molecular weight of up to 500,000 g/mol.

19. The method of claim 15, wherein the first polymer and the second polymer have difference viscosities.

20. The method of claim 15 further comprising forming a biaxial-orientated film, a fiber, a sealant, a roto-molding powder, or a foam.
